(19) United States
(12) Patent Application Publication
(10) Pub. No.: US 2019/0336256 A1
(43) Pub. Date: Nov. 7, 2019

(54) Adjustable Whole Mouth Toothbrush

(71) Applicants: Michael John Sze, Dallas, TX (US); Tanya Sze, Dallas, TX (US)

(72) Inventors: Michael John Sze, Dallas, TX (US); Tanya Sze, Dallas, TX (US)

(21) Appl. No.: 15/932,831

(22) Filed: May 3, 2018

(51) Int. Cl. A61C 17/22; A46B 15/00; A46B 9/06; A46B 5/00

(52) U.S. Cl. CPC A61C 17/228; A61C 17/222; A46B 5/0083; A46B 9/06; A46B 15/0081

(57) ABSTRACT

Adjustable whole mouth toothbrush can fit most people. One way to make the toothbrush adjustable is by making it in a modular fashion. Additional sections can be added as necessary for that individual. For further flexibility, an embedded string is an option to allow even more adjustability.

### US PATENT DOCUMENTS

| | |
|---|---|
| 4,011,6116 | March 1977 Kennedy et al. |
| 4,131,967 | January 1979 Northeman et al. |
| 4,223,417 | September 1980 Solow |
| 4,224,710 | September 1980 Solow |
| 4,237,574 | December 1980 Kelly et al. |
| 4,382,309 | May 1983 Collis |
| 4,449,266 | May 1984 Northemann et al. |
| 4,488,328 | December 1984 Hyman |
| 4,757,570 | July 1988 Haeusser et al. |
| 4,796,325 | January 1989 Bortman |
| 4,876,157 | October 1989 Barman |
| 4,972,542 | November 1990 Moshos et al. |
| 5,072,481 | December 1991 Weyer |
| 5,137,039 | August 1992 Klinkhammer |
| 5,148,567 | September 1992 Daub |
| 5,171,066 | December 1992 Klinkhammer |
| 5,175,901 | January 1993 Robinowitz |
| 5,177,826 | January 1993 Vrignaud et al. |
| 5,228,466 | July 1993 Klinkhammer |
| 5,305,491 | April 1994 Hegemann |
| 5,327,607 | July 1994 Wagner |
| 5,351,358 | October 1994 Larrimore |
| 5,360,025 | November 1994 Klinkhammer |
| 5,407,254 | April 1995 Hegemann |
| 5,497,526 | March 1996 Klinkhammer |
| 5,673,454 | October 1997 Quintanilla et al. |
| 5,758,380 | June 1998 Vrignaud |
| 5,758,383 | June 1998 Hohlbein |
| 5,765,249 | June 1998 Axelrod |
| 5,839,149 | November1998 Scheier et al. |
| 5,864,911 | February 1999 Arnold et al. |
| 5,934,762 | August 1999 Vrignaud |
| 5,946,758 | September 1999 Hohlbein |
| 5,991,958 | November 1999 Hohlbein |
| 6,067,684 | May 2000 Kweon |
| 6,108,852 | August 2000 Vrignaud |
| 6138,310 | October 2000 Porper et al. |
| 6,286,173 | September 2001 Brions |
| 6,343,396 | February 2002 Simovitz |
| 6,381,794 | May 2002 Porper et al. |
| 6,401,288 | June 2002 Porper |
| 6,823,554 | November 2004 Braun et al. |
| 7,036,180 | May 2006 Hanlon |
| 8,316,496 | November 2012 Al-Quaffas |
| 8,448,282 | February 2013 Stapelbroek et al. |
| 8,584,291 | November 2013 Thompson |
| 8,631,531 | January 2014 Garner et al. |
| 8,635,731 | January 2014 Garner et al. |
| 8,677,541 | March 2014 Meadows et al. |
| 8,684,956 | April 2014 Mcdonough et al. |
| 8,745,802 | June 2014 Steur |
| 8,793,830 | August 2014 Stapelbroek et al. |
| 8,990,992 | March 2015 Stapelbroek et al. |
| 8,978,189 | August 2015 Sexton |

### FIELD OF INVENTION

This invention is in the realm of toothbrushes, more specifically, whole mouth toothbrushes.

### BACKGROUND

Typical toothbrushes brush a section of the lingual, facial, or occlusal surface of the teeth at a time. On the other hand, a whole mouth toothbrush cleans all the teeth simultaneously, such as the Blizzident toothbrush. However, Blizzident toothbrushes need to be custom made for each individual due to variations in each person. This is very costly and time consuming.

### SUMMARY OF THE INVENTION

One way to produce whole mouth toothbrushes that will fit most people is to make an adjustable modular toothbrush. One iteration, which would not exclude other variations, would include partially assembled whole mouth toothbrush. Additional sections can be added in a modular fashion by the customer, like Lego pieces, so that it would fit each individual. The toothbrush can come entirely unassembled, partially assembled, or fully assembled. The consumer, manufacturer, or secondary market can fine tune the toothbrush for a proper fit such as by providing a bite template or simply by trial and error of adding or removing pieces until a proper fit is achieved.

Pieces can be added by some sort of connector or joint. The connector/joint will have a degree of flexibility, which helps to mold to the teeth of each individual. Connector configurations can vary. The connectors can be made out of polymer, nylon, plastic, boars hair, bamboo, fiber, metal, wire, or any material that serves the purpose of joining objects together. Connectors can be made water resistant by different methods. Connectors can be sealed with sealant, adhesive, compound, plastic, or polymer to prevent water intrusion. Joints or connectors may even be wrapped. Wrapper or sealant may or may not require activation such as by heat, microwave, oven, boiling, hair dryer, or by other methods such as exposure to air or environmental conditions.

Teeth cleaning element will be with bristles, similar to a conventional toothbrush. Brushing is done by biting down on the whole mouth toothbrush and releasing. This is repeated until the teeth are clean. Brushing can also be driven by a motor, such as with an electric toothbrush. The bristles can extend down past the teeth to brush the gums. Bristles can also be made of different configurations, such as a Christmas tree design.

In a partially or fully assembled adjustable whole mouth toothbrush, a string or wire that can be made of different materials may be embedded or enclosed in the toothbrush to allow for adjustments to the toothbrush. The string or wire maybe adjusted by a knob at the handle. In addition a section maybe attached at various angles to brush the tongue and roof of the mouth.

### DESCRIPTION OF DRAWINGS

FIG. 1 is a side view of the adjustable whole mouth toothbrush.

FIG. 2 is a top view of the adjustable whole mouth toothbrush.

FIG. 3 is an on end view of the toothbrush.

FIG. 4 is a cross sectional view of the toothbrush.

FIG. 5A is a cross sectional view of the toothbrush with connectors.

FIG. 5B is an exploded view of a connector

FIG. 5C is an exploded view of another type of connector

FIG. 6 is a view with Christmas tree bristles

FIG. 7 is a toothbrush with adjustable strings

FIG. 8 is a toothbrush with a section for brushing the tongue and roof of the mouth

### DETAILED DESCRIPTION OF INVENTION

This adjustable toothbrush can be made in a modular fashion. One embodiment would include a partially assembled whole mouth toothbrush. Additional sections can be assembled in a modular fashion. Therefore, varying individuals may require adding different number of sections to the already assembled partial toothbrush. The flexibility will allow customers to tailor make their whole mouth toothbrushes, which would be much more cost effective. The customers will have the option of having the manufacturer or secondary source to fine tune or adjust their toothbrushes. Customers can provide a bite template or simply by trial and error of adding or removing sections until a proper fit is achieved.

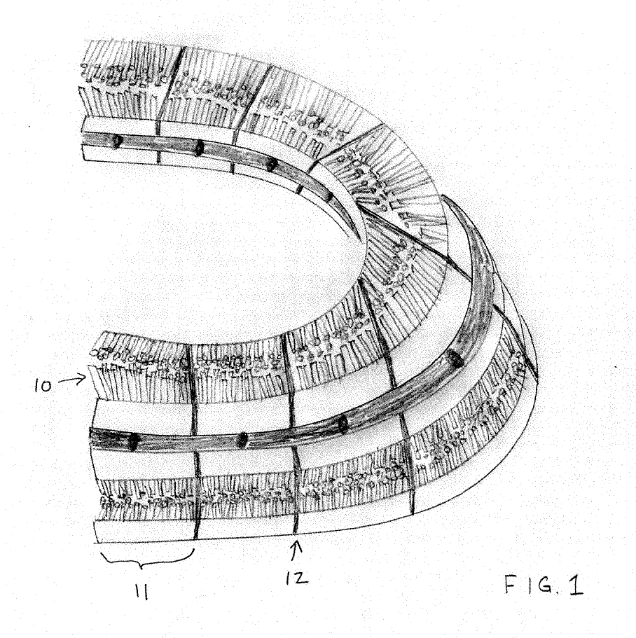

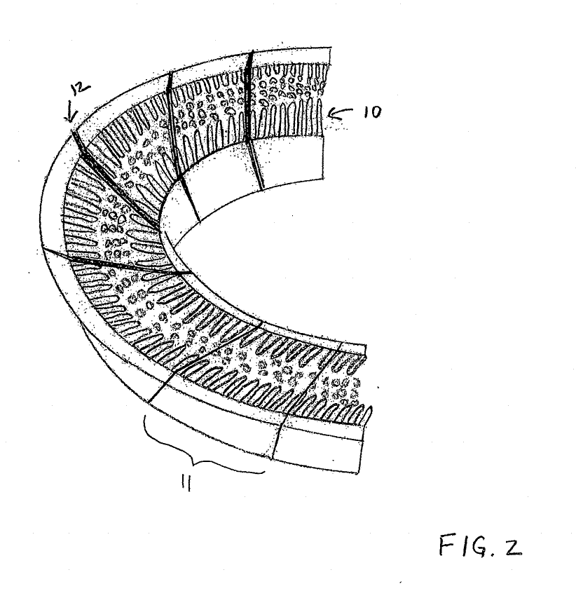

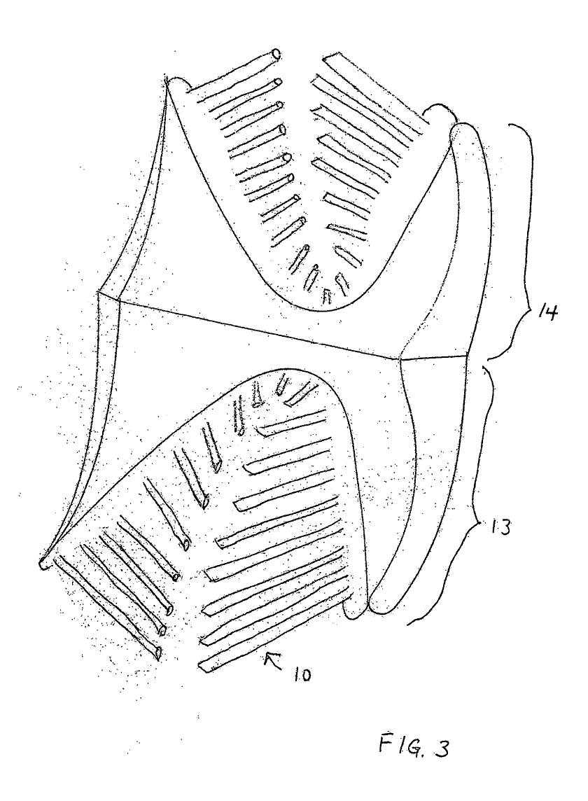

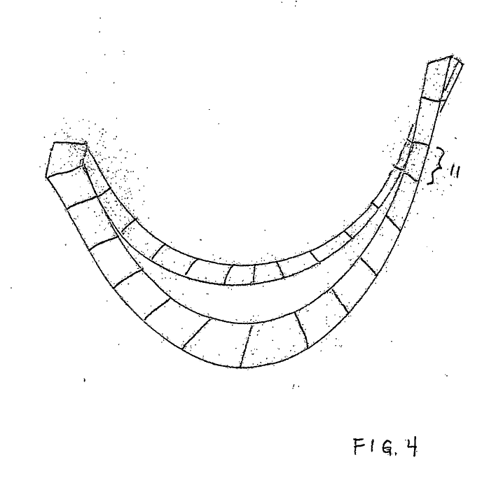

FIG. 1 is a side view of the adjustable whole mouth toothbrush. FIG. 2 is a top view of the adjustable whole mouth toothbrush. FIG. 3 is an on end view of the toothbrush. FIG. 4 is a cross sectional view of the toothbrush. Sections 11 can be connected by connectors 12. The whole mouth toothbrush has a mandibular section 13 to clean the mandibular teeth and a maxillary section 14 to clean the maxillary teeth.

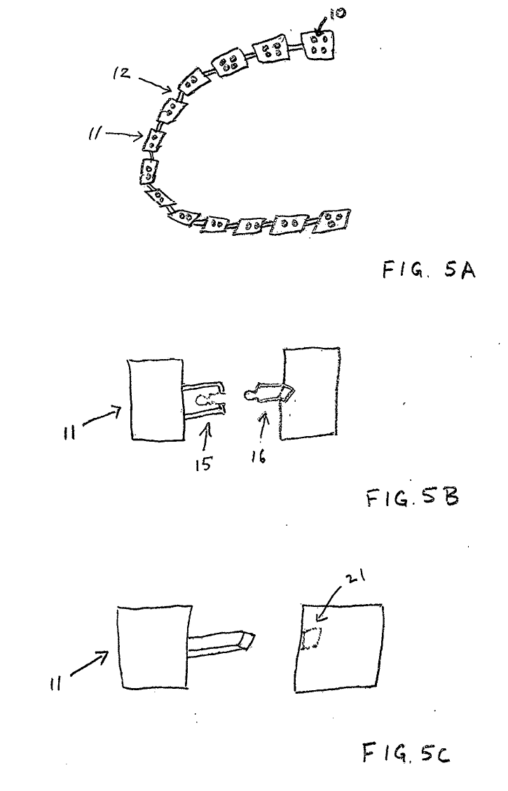

FIG. 5A is another cross sectional view of the whole mouth toothbrush. FIG. 5B shows an exploded view of one embodiment of a connector. The connector or joint can vary, as long as it serves the purpose of joining separate parts together. A connector can have different configurations then illustrated, and it can be made of various materials. A connector can be made out of polymer, nylon, plastic, boars hair, bamboo, fiber, metal, wire, or any material that serves the purpose of joining objects together. Connectors can be made water resistant by different methods. Connectors can be sealed with sealant, adhesive, compound, plastic, or polymer to prevent water intrusion. Connectors may even be wrapped to prevent water intrusion. Wrapper or sealant may or may not require heat activation such as by freezing, microwave, oven, boiling, hair dryer, or any other temperature sensitive method. Maybe activation can be achieved by exposure to air or environmental conditions. Female connector 15 can be joined to the male connector 16 to form a joint. FIG. 5C is another example of a connector. Male connector part 16 can be joined to the receptacle 21 to connect the sections.

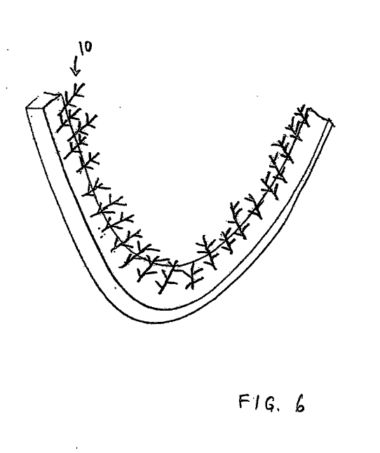

Teeth cleaning element will be with bristles, similar to a standard toothbrush. Bristles can come in different configurations such as a Christmas tree design 10 in FIG. 6. Brushing is done by biting down on the toothbrush and releasing. This is repeated until the teeth are clean. Brushing can also be driven by a motor such as with an electric toothbrush. The bristles can extend down to brush the gums.

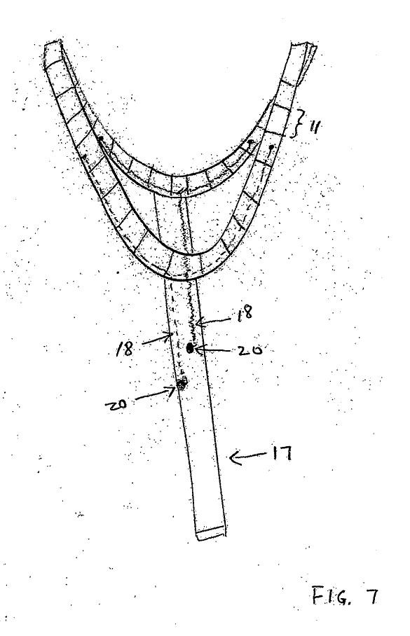

In a partially or fully assembled adjustable whole mouth toothbrush, a string made of different materials maybe embedded or enclosed to allow for further adjustments. The string, FIG. 7, 18, can be made with various materials, such as wire, metal, polymer, nylon, plastic, boars hair, fiber, or other materials. The string can be adjusted by a knob 20 at the handle 17. The invention is not limited by the drawings. The embodiments are meant as examples. The embodiments are not intended to limit the invention in any manner.

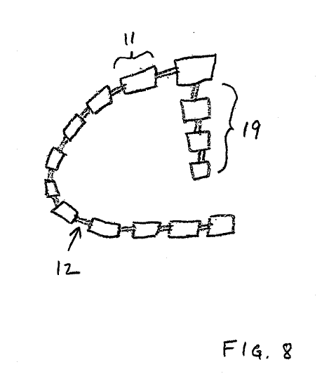

The toothbrush may have an option of an additional section for brushing the tongue and the roof of the mouth, FIG. 8, 19.

We claim:

1. This can be a whole mouth toothbrush. This toothbrush can brush both the maxillary and mandibular teeth simultaneously.

2. Toothbrush is adjustable so that it fits people with different size jaws.

3. Toothbrush can be partly or entirely modular where sections of toothbrush can be added as necessary for different individuals.

4. Connectors for the different sections of toothbrush can be flexible allowing a more comfortable fit. Connector type, configuration, shape, and size can vary.

5. Connectors may be sealed for water resistance.

6. Toothbrush may have embedded strings to allow for further adjustments

7. Different bristles may be utilized in this toothbrush including the Christmas configuration

8. Toothbrush may have a handle.

9. Section of toothbrush may be added for brushing the tongue and roof of the mouth
